(19) United States
(12) Patent Application Publication
(10) Pub. No.: US 2016/0115668 A1
(43) Pub. Date: Apr. 28, 2016

(54) DEPLOYABLE DRAIN COVERS AND METHODS FOR USING SAME

(71) Applicant: DELTA COMPOSITES, L.L.C., Spring, TX (US)

(72) Inventor: William Dean Halbirt, Spring, TX (US)

(73) Assignee: DELTA COMPOSITES, L.L.C., Spring, TX (US)

(21) Appl. No.: 14/921,314

(22) Filed: Oct. 23, 2015

Related U.S. Application Data
(60) Provisional application No. 62/068,479, filed on Oct. 24, 2014.

(51) Int. Cl. E02D 29/14; F16J 13/12; F16J 13/04

(52) U.S. Cl. CPC E02D 29/14; F16J 13/04; F16J 13/12

(57) ABSTRACT

A deployable drain cover system and method for installing the same are provided. The drain cover system can include at least one cover plate having at least one hole formed therethrough. A top plate also having a hole formed therethrough can be disposed on an upper surface of the cover plate. A fastener having a gripping mechanism located on a lower portion thereof can be disposed through the holes of the top plate and the cover plate. A block can be used to hold the gripping mechanism to the fastener. The cover plate is preferably made of a fiber reinforced plastic such as fiberglass.

### BACKGROUND OF THE INVENTION

1. Field of the Invention

Embodiments described generally relate to deployable drain covers and methods for using same. More particularly, embodiments described relate to deployable covers for storm or vent drains during flooding conditions.

2. Description of the Related Art

Combined sewer systems (“CSS”) use a single piping system to collect storm water runoff and sewage. During times of heavy rains and flooding, the sewage treatment capacity can be exceeded and the combined sewage overflow will go directly into receiving waters, such as a river, stream, lake, or ocean. Such discharge can cause serious water pollution problems.

In addition to water pollution problems, flooding can severely damage the sewage treatment plants and pumping stations. Most often below sea level, sewer pumps can remain waterlogged and incapacitated long after the floodwaters recede. Consequently, the sewer systems can remain full of water until other relief is provided, disabling a city's sewer system for days or weeks depending on the severity on the flooding, i.e., tidal waves, tsunami, typhoons, hurricanes, etc.

There is a need, therefore, for an improved system and methods for protecting underground sewage systems from flood waters.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a top view of an illustrative cover plate, according to one or more embodiments described.

FIG. 2 depicts a bottom view of the cover plate of FIG. 1, according to one or more embodiments described.

FIG. 3 depicts a partial section view of the cover plate of FIG. 1.

FIG. 4 depicts a partial cross section view of the cover plate system that has been assembled on a storm drain grating, according to one or more embodiments described.

FIG. 5 depicts a partial section view of a splice plate for use between adjoining cover plates, according to one or more embodiments described.

FIG. 6 depicts a schematic view of an assembled deployable drain cover system, according to one or more embodiments described.

FIG. 7 depicts an illustrative side section view of the assembled deployable drain cover system depicted in FIG. 6.

### DETAILED DESCRIPTION

A deployable storm or vent drain cover system is provided. The system can be deployed in anticipation of flooding conditions, whether caused by heaving rains or natural disasters. The system is capable of forming a seal against existing storm drains to prevent or substantially retard water from passing through. The system is modular and can be easily assembled. The system can also be scaled up or down, depending on the size of the storm drain to be covered. The system is particularly useful for municipalities that have underground subways and pumping stations.

The drain cover system can include at least one cover plate having at least one hole formed therethrough. A top plate also having a hole formed therethrough can be disposed on an upper surface of the cover plate. A fastener having a gripping mechanism located on a lower portion thereof can be disposed through the holes of the top plate and the cover plate. A block can be used to hold the gripping mechanism to the fastener.

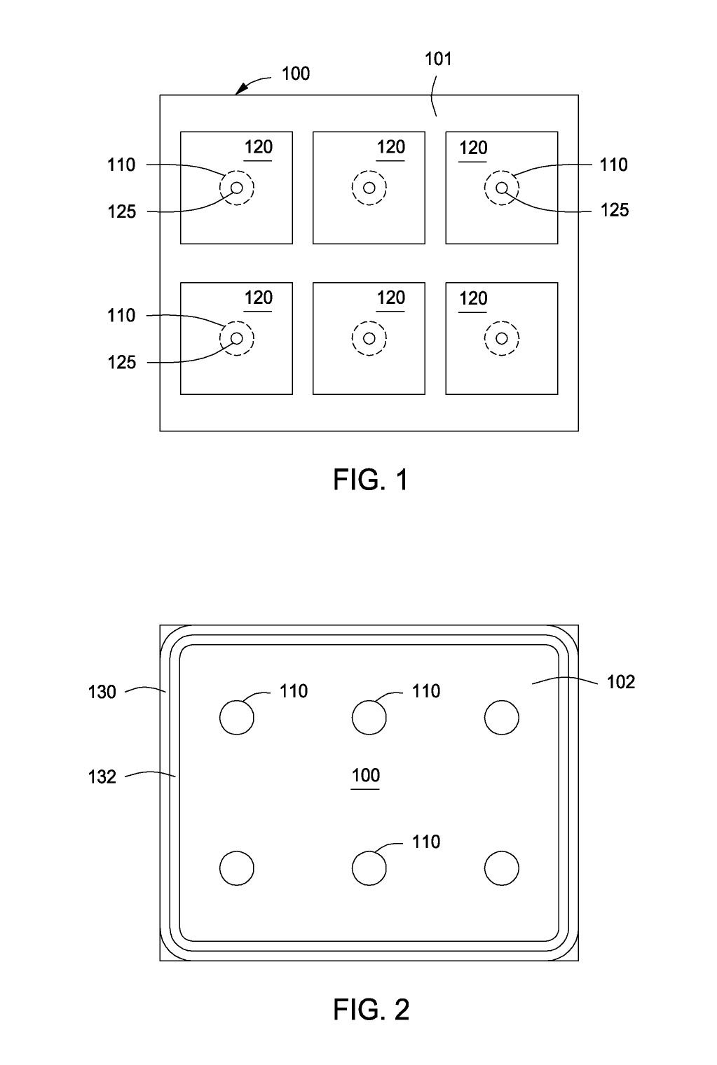

FIG. 1 depicts a top view of an illustrative cover plate 100, according to one or more embodiments described. The cover plate 100 can be any shape or size, and is preferably square or rectangular. The cover plate 100 can have a plurality of holes or apertures 110 formed therethrough. Although six holes 110 are depicted in FIG. 1, any number of holes 110 can be used and will depend on the size of the cover plate 100.

A top plate 120 can be disposed or otherwise located on an upper or top surface of the cover plate 100. The number of top plates 120 corresponds to the number of holes 110 formed in the cover plate 100. For each hole 110 formed in the cover plate 100, one top plate 120 can be used to cover the hole 110. The holes 110 in the cover plate 100 can be larger than the hole 125 in the top plate 120. For example, the holes 110 can be anywhere from two, five, ten times the diameter of the hole 125 in the top plate 120. For reasons discussed in more detail below, this size differential allows greater flexibility and eases the assembly of the cover system.

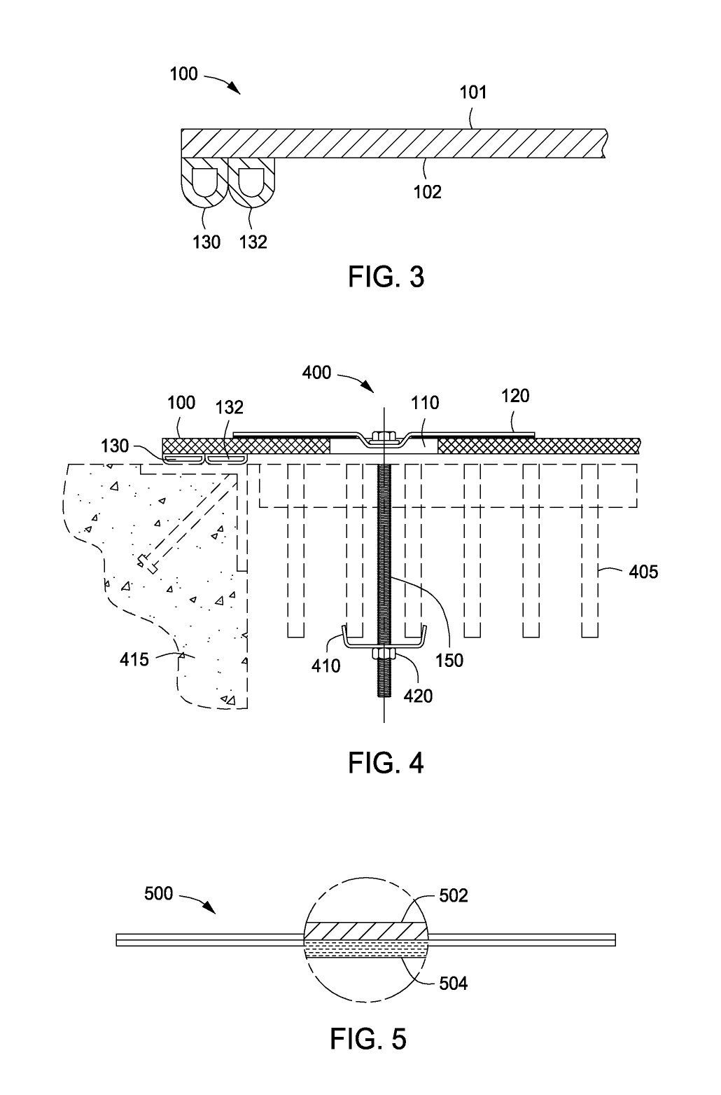

FIG. 2 depicts an illustrative bottom view of the cover plate 100 of FIG. 1 and FIG. 3 depicts a partial section view of the cover plate 100. Referring to FIGS. 2 and 3, the cover plate 100 can have an upper or top surface 101 and a lower or bottom surface 102. The bottom or lower surface 102 of the cover plate 100 can have at least one sealing member 130 disposed thereon. Two sealing members 130, 132 are shown although any number of sealing members can be used. Each sealing member 130, 132 can be made of a material that is capable of forming a water tight or at least water resilient seal when compressed.

Referring again to FIG. 1, the top plate 120 can be any shape or size, and is preferably square or rectangular. The top plate 120 can have a hole or aperture 125 formed therethrough. As will be explained in more detail below, the hole 125 of the top plate 120 can be aligned with the hole 110 of the cover plate 100, allowing a fastener 150 (depicted in FIG. 4) to pass through the aligned holes 110, 125.

The top plate 120 can be substantially smaller in size than the cover plate 100 and serves as a stop or backing for the fastener 150. The top plate 120 can have a bottom or lower surface that is lined or made from a water resilient material, such as rubber, neoprene, or the like. So when assembled, the top plate 120 forms a seal around the hole 110 of the cover plate 100.

FIG. 4 depicts a partial cross section view of the drain cover system 400 assembled on a storm drain, according to one or more embodiments. The drain cover system 400 includes the cover plate 100 and top plate 120 discussed above. The drain cover system 400 further includes a fastener 150 that is inserted through the hole 125 of the top plate 120 and the hole 110 of the cover plate 100. The fastener 150 can be any type of elongated rod, pin, or screw that can be inserted through the holes 110, 125 of their respective plates 100, 120. For example, the fastener 150 can be a hex bolt or the like. An or-ring or other sealing member can be used between the head of the fastener 150 and the top surface of the top plate 120 to further prevent the passage of water.

The drain cover system 400 can further include a gripping mechanism 410 that clamps or otherwise secures itself to the grating 400 of the storm/vent drain. The gripping mechanism 410 can be located on a lower portion of the fastener 150, and a block 420 can be used to hold or secure the gripping mechanism 410 to the fastener 150. The gripping mechanism 410 can be any suitable device capable of clamping onto or engaging the grating 400, which is typically supported against a concrete basin 405. The storm or vent drain grating 400 is typically made of rectangular or squared shaped, steel cross members so the gripping mechanism 410 is preferably a u-shaped bar with a hole through the middle, allowing the mechanism 410 to move freely about the fastener 150. The gripping mechanism 410 can be sized to engage or lock onto the adjoining cross members (bars) of the grate 400.

The block 420 can be threaded onto the fastener 150 to hold the gripping mechanism 410 on the fastener 150. The block 420 can be any type of threaded nut or suitable substitute. During assembly, the fastener 150 can be turned and tightened against the block 420 until the gripping mechanism 410 wedges between the bars of the grating 400. Once the gripping mechanism 410 is anchored against the grating, the cover system is locked in place.

Any number of the foregoing cover systems can be used to block a storm or vent drain. For example, two or more cover systems can be arranged side by side or end to end, depending on the size and shape of the drain. The cover plates 100 can have a length that ranges from a low about 1, 1.5, or 2 feet to a high of about 3, 4, or 6 feet or more. The width of the cover plates 100 can range from a low about 1, 1.5, or 2 feet to a high of about 2.5, 3, or 4 feet or more. Depending on the overall dimensions of the storm drain to be covered, any number of cover plates 100 can be used. To facilitate assembly, a splice plate 500 can be used between adjoining cover plates 100.

FIG. 5 depicts a partial section view of a splice plate 500 for use between adjoining cover plates 100, according to one or more embodiments. The splice plate 500 can be disposed between and underneath adjoining cover plates 100 and serves as bridge between adjoining cover plates 100. The splice plate 500 can have a top or upper surface 502 and a bottom or lower surface 504. The top surface 502 can be made of any suitable material, including stainless steel. The lower surface 504 is preferably made of or has a water resilient material disposed thereon. As will be explained in more detail below, the lower surface 504 of the splice plate 500 forms a water tight or at least water resilient seal against the support structure that holds the storm grating. In turn, the sealing members 130, 132 located on the cover plate 100 seals against the upper surface 502 of the splice plate 500.

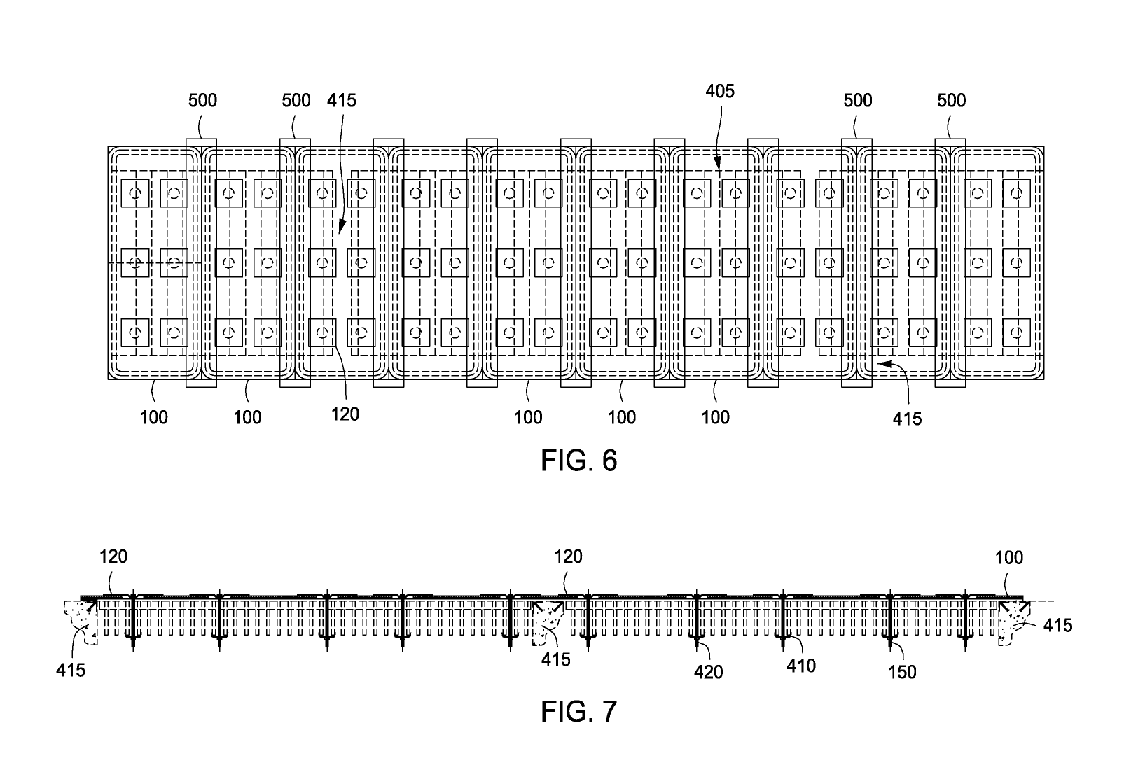

FIG. 6 depicts an illustrative schematic view of an assembled deployable drain cover system, according to one or more embodiments, and FIG. 7 depicts an illustrative side section view of the assembled deployable drain cover system depicted in FIG. 6. To assemble the drain cover, a splice plate 500 is laid on a front or top side of the sewer grate 405. A first cover 100 is laid or disposed on at least a portion of the splice plate 500, and a second cover 100 is laid or disposed on at least a portion of the splice plate 500 next to the first cover 100 so the cover plates 100 are side by side and bridged underneath by the splice plate 500. The top plates 120 are disposed over some or all of the holes 110 in the cover plate 100. A fastener 150 is inserted through the holes 110, 125 of the cover plate 100 and top plate 120, respectively.

A gripping mechanism 410 is then placed on the fastener 150 and a block 420 is secured to the fastener 150, beneath the gripping mechanism 410. The fastener 150 is then tightened to draw the gripping mechanism 410 toward the cover plate 100 and against the grating 400 to secure the gripping mechanism 410 to the back side of the grating 400.

Once the gripping mechanism 410 is anchored against the grating 400, additional turns of the fastener 150 draws the top plate 120 toward the cover plate 100 thereby compressing the resilient lower surface of the top plate 120 against the cover plate 100. This same compressive force compresses the sealing members between the cover plate 100 and the splice plate 500, providing a water tight or substantially water tight seal therebetween.

Depending on how tight the fastener 150 becomes, a portion of the top plate 120 can deflect or draw into the hole 110 of the cover plate 100. As such, the top of the fastener 150 can be level with the top plate 120, if not recessed below it, eliminating any tripping hazards to pedestrians walking over the assembled drain cover assembly.

To remove and disassemble the cover system 400, each fastener 150 is loosened until the gripping member 410 releases the grating 405. The fastener 150 can then be manipulated to orient the gripping member 410 so the fastener 150, gripping member 410, and block 420 can be lifted between the cross members of the grating 405 and removed. Once the fastener 150 is removed, the top plate 120 comes off and the cover plates 100 and splice plates 500 can be retrieved and put away.

As grating is made to different specification and sizes and by different manufacturers, the spacing or distance between the cross members of the grating can vary. The larger holes 110 on the cover plate 100 facilitate alignment and assembly of the cover system by allowing the fastener 150 and top plate 120 to move or adjust, so that the fastener 150 can fit between the cross members of the grating. Otherwise, the top plates 100 and/or splice plates 500 would have to be lifted and moved to provide the proper alignment for the grating.

The cover plates 100 are preferably made from one or more fiber reinforced plastics, such as one or more fiberglass composites. Any suitable material, however, can be used to fabricate the plates 100, 120 and any other individual component (seal, plate, and mechanism) discussed herein. Such suitable materials include, but are not limited to, any one or more metals (such as aluminum, steel, stainless steel, brass, nickel), wood, other composite materials (such as ceramics, wood/polymer blends, cloth/polymer blends, etc.), and plastics (such as polyethylene, polypropylene, polystyrene, polyurethane, polyethylethylketone (PEEK), polytetrafluoroethylene (PTFE), polyamide resins (such as nylon 6 (N6), nylon 66 (N66)), polyester resins (such as polybutylene terephthalate (PBT), polyethylene terephthalate (PET), polyethylene isophthalate (PEI), PET/PEI copolymer) polynitrile resins (such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS)), polymethacrylate resins (such as polymethyl methacrylate and polyethylacrylate), cellulose resins (such as cellulose acetate and cellulose acetate butyrate); polyimide resins (such as aromatic polyimides), polycarbonates (PC), elastomers (such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like)), and mixtures, blends, or copolymers of any and all of the foregoing materials.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A deployable drain cover system, comprising:
a cover plate having at least one hole formed therethrough;
a top plate disposed on an upper surface of the cover plate, the top plate having a hole formed therethrough;
a fastener disposed through the holes of the top plate and the cover plate;
a gripping mechanism located on a lower portion of the fastener; and
a block for holding the gripping mechanism to the fastener.

2. The system of claim 1, wherein the cover plate is made of fiberglass.

3. The system of any preceding claim, wherein the cover plate comprises at least one sealing member disposed about a perimeter thereof.

4. The system of any preceding claim, wherein the top plate has a bottom surface made of a water resilient material.

5. The system of any preceding claim, wherein the gripping mechanism is a u-shaped bar.

6. The system of any preceding claim, wherein the gripping mechanism is a u-shaped bar sized to lock onto adjoining bars of steel grating.

7. The system of any preceding claim, wherein the hole of the cover plate is larger than the hole of the top plate.

8. The system of any preceding claim, wherein the top plate substantially covers the hole of the cover plate.

9. A deployable drain cover system, comprising:
two or more cover assemblies, each cover assembly comprising:
a cover plate having at least one hole formed therethrough;
a top plate disposed on an upper surface of the cover plate, the top plate having a hole formed therethrough;
a fastener disposed through the holes of the top plate and the cover plate;
a gripping mechanism located on a lower portion of the fastener; and
a block for holding the gripping mechanism to the fastener.
a splice plate disposed between and underneath adjoining cover assemblies, the splice plate having a bottom surface made of a water resilient material.

10. The system of claim 9, wherein the cover plate comprises at least one sealing member disposed about a perimeter thereof.

11. The system of claim 10, wherein a portion of sealing member on the cover plate contacts a top surface of the splice plate.

12. The system according to any claim 9 to 11, wherein the cover plate is made of fiberglass.

13. The system according to any claim 9 to 12, wherein the top plate has a bottom surface made of a water resilient material.

14. The system according to any claim 9 to 13, wherein the gripping mechanism is a u-shaped bar.

15. The system according to any claim 9 to 14, wherein the gripping mechanism is a u-shaped bar sized to lock onto adjoining bars of steel grating.

16. The system according to any claim 9 to 15, wherein the hole of the cover plate is larger than the hole of the top plate.

17. The system according to any claim 9 to 16, wherein the top plate substantially covers the hole of the cover plate.

18. A method for installing a deployable drain cover system, comprising:
locating a splice plate on a front side of a sewer grate, the splice plate having a bottom surface made of a water resilient material;
locating a first cover assembly on at least a portion of the splice plate;
locating a second cover assembly next to the first cover assembly and on at least a portion of the splice plate, each cover assembly comprising:
a cover plate having at least one hole formed therethrough;
a top plate disposed on an upper surface of the cover plate, the top plate having a hole formed therethrough;
a fastener disposed through the holes of the top plate and the cover plate;
a gripping mechanism located on a lower portion of the fastener; and
a block for holding the gripping mechanism to the fastener; and
tightening the fastener to draw the gripping mechanism toward the cover plate and secure the gripping mechanism to a back side of the sewer grate.
